(19) United States
(12) Patent Application Publication
(10) Pub. No.: US 2022/0342492 A1
(43) Pub. Date: Oct. 27, 2022

(54) MOUSE PAD WITH USABLE DOUBLE SURFACE

(71) Applicant: Hung-Jen CHOU, Taipei City (TW)

(72) Inventor: Hung-Jen CHOU, Taipei City (TW)

(21) Appl. No.: 17/719,956

(22) Filed: Apr. 13, 2022

(30) Foreign Application Priority Data
Apr. 22, 2021 (TW) 110204473

(51) Int. Cl. G06F 3/039; B32B 7/022; B32B 7/12

(52) U.S. Cl. CPC G06F 3/0395; B32B 7/022; B32B 7/12; B32B 2250/03; B32B 2250/04; B32B 2307/732; B32B 2307/536; B32B 2307/744

(57) ABSTRACT

A mouse pad with usable double surface includes a pad main body having a first pad plate and a second pad plate stacked on the first pad plate, and a thickness of the first pad plate is greater than a thickness of the second pad plate. Accordingly, two surfaces of the pad main body have different smoothness, and a user may freely choose the desired surface to use to increase the usable convenience of the mouse pad.

### BACKGROUND OF THE DISCLOSURE

### Technical Field

The present disclosure relates to a mouse pad structure, particularly to a mouse pad with usable double surface.

### Description of Related Art

When using a computer, a mouse is held by a user's hand for controlling the displacement of a cursor and for imputing signals, and the mouse often works with a mouse pad. With the mouse being displaced on a smooth and flat surface of the mouse pad, the mouse may be smoothly operated and precisely sense the displacement.

However, the smoother the contact surface between the mouse pad and the mouse, the smoother the cursor of the mouse may displace, but signals are hard to be reflected if the contact surface is overly smooth. As such, a mouse pad having a contact surface with a proper smoothness needs to be developed.

Accordingly, the applicant of the present disclosure has devoted himself for improving the mentioned disadvantages.

### SUMMARY OF THE DISCLOSURE

The present disclosure is to provide a mouse pad with usable double surface, in which two surfaces of a pad main body have different smoothness, and a user may freely choose the desired surface to operate to increase the usable convenience of the mouse pad.

Accordingly, the present disclosure provides a mouse pad with usable double surface, which includes: a pad main body, having a first pad plate and a second pad plate stacked on the first pad plate, and a thickness of the first pad plate is greater than a thickness of the second pad plate.

Accordingly, the present disclosure provides a mouse pad with usable double surface, which includes: a pad main body, having a first pad plate and a second pad plate stacked on the first pad plate, and a hardness of the first pad plate is greater than a hardness of the second pad plate.

### BRIEF DESCRIPTION OF THE DRAWINGS

The features of the disclosure believed to be novel are set forth with particularity in the appended claims. The disclosure itself, however, may be best understood by reference to the following detailed description of the disclosure, which describes a number of exemplary embodiments of the disclosure, taken in conjunction with the accompanying drawings, in which:

FIG. 1 is a perspective exploded view showing a mouse pad according to the present disclosure;

FIG. 2 is a perspective view showing the assembly of the mouse pad according to the present disclosure;

FIG. 3 is a cross sectional view showing the mouse pad according to the present disclosure;

FIG. 4 is a schematic view showing a usable status of the mouse pad according to the present disclosure;

FIG. 5 is a perspective view showing the assembly of the mouse pad according to another embodiment of the present disclosure;

FIG. 6 is a cross sectional view showing the mouse pad according to another embodiment of the present disclosure;

FIG. 7 is a perspective view showing the assembly of the mouse pad according to still another embodiment of the present disclosure; and

FIG. 8 is a cross sectional view showing the mouse pad according to still another embodiment of the present disclosure.

### DETAILED DESCRIPTION OF THE EMBODIMENTS

The technical contents of this disclosure will become apparent with the detailed description of embodiments accompanied with the illustration of related drawings as follows. It is intended that the embodiments and drawings disclosed herein are to be considered illustrative rather than restrictive.

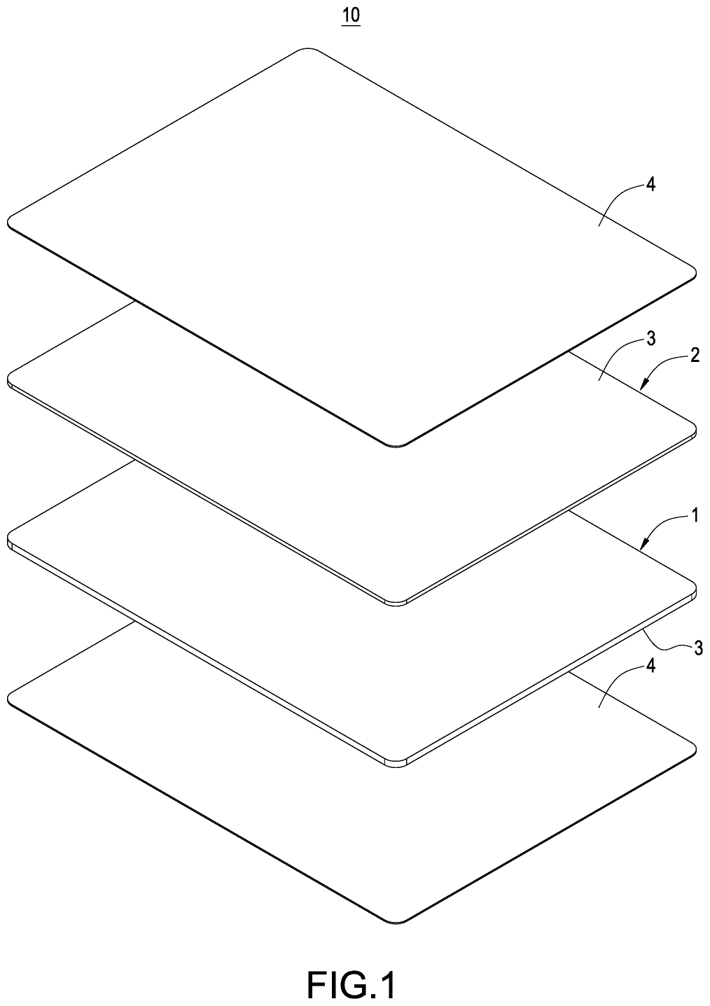

Please refer from FIG. 1 to FIG. 4, the present disclosure provides a mouse pad with usable double surface, and the mouse pad mainly includes a pad main body 10.

As shown from FIG. 1 to FIG. 4, the pad main body 10 includes a first pad plate 1 and a second pad plate 2. A hot-melting adhesive is disposed between the first pad plate 1 and the second pad plate 2 to make the second pad plate 2 be stacked on the first pad plate 1. A material of which the first pad plate 1 is made is the same as a material of which the second pad plate 2 is made. A thickness h1 of the first pad plate 1 is greater than a thickness h2 of the second pad plate 2.

Please refer from FIG. 1 to FIG. 4, the mouse pad of the present disclosure further includes two surface layers 4. The first pad plate 1 and the second pad plate 2 jointly have two outer surfaces 3, and the two surface layers 4 are respectively adhered on the two outer surfaces 3. The surface layer 4 is a fabric layer or a plastic membrane layer, and the surface layer 4 is used for decorating and protecting the first pad plate 1 and the second pad plate 2.

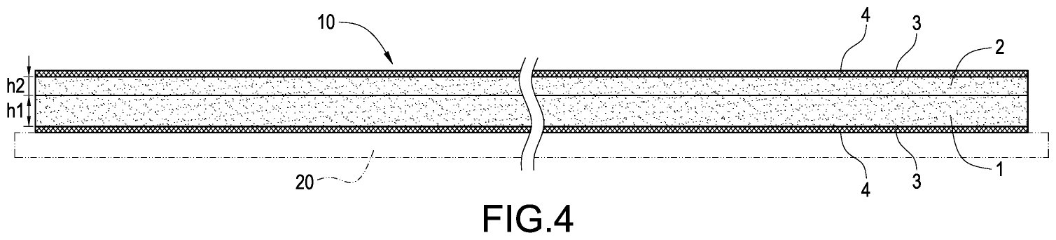

As shown in FIG. 4, the mouse pad of the present disclosure further includes an anti-slippery pad 20. The pad main body 10 is disposed on the anti-slippery pad 20 to make the pad main body 10 be stably positioned on the anti-slippery pad 20.

The first pad plate 1 and the second pad plate 2 may be hard plastic, silicone, rubber, or any plastic foaming material such as thermoplastic rubber (TPE), thermoplastic polyurethane (TPU), and ethylene/ethylene-vinyl acetate copolymer (EVA). The surface layer 4 is a fabric layer or a plastic membrane layer. The anti-slippery pad 20 is consisted of a colloid (for example rubber or silicone) or a fabric material.

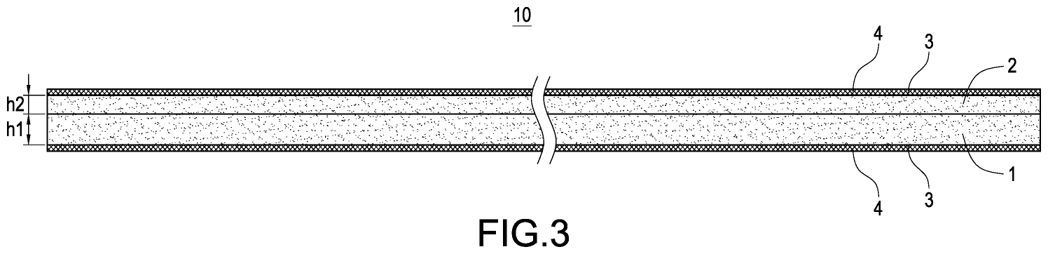

Please refer to FIG. 3 and FIG. 4, which disclose a usable status of the mouse pad of the present disclosure. The pad main body 10 includes the first pad plate 1 and the second pad plate 2 stacked on the first pad plate 1. The material of which the first pad plate 1 is made is the same as the material of which the second pad plate 2 is made. The thickness h1 of the first pad plate 1 is greater than the thickness h2 of the second pad plate 2, thus a surface of the first pad plate 1 is less likely to be deformed relative to a surface of the second pad plate 2, and two surfaces of the pad main body 10 have different smoothness. As such, a user may freely choose the desired surface to use to increase the usable convenience of the mouse pad.

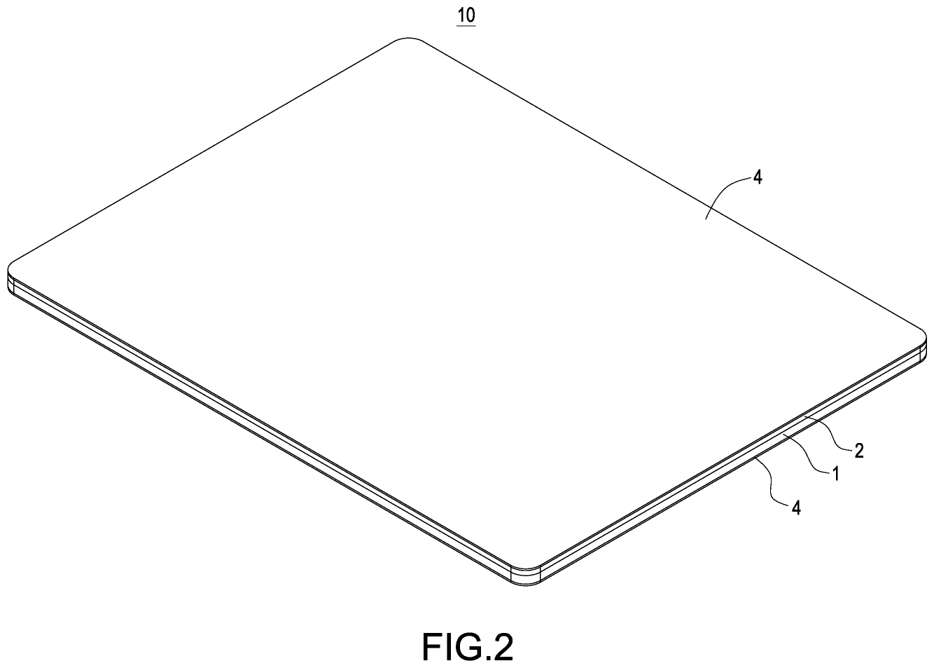

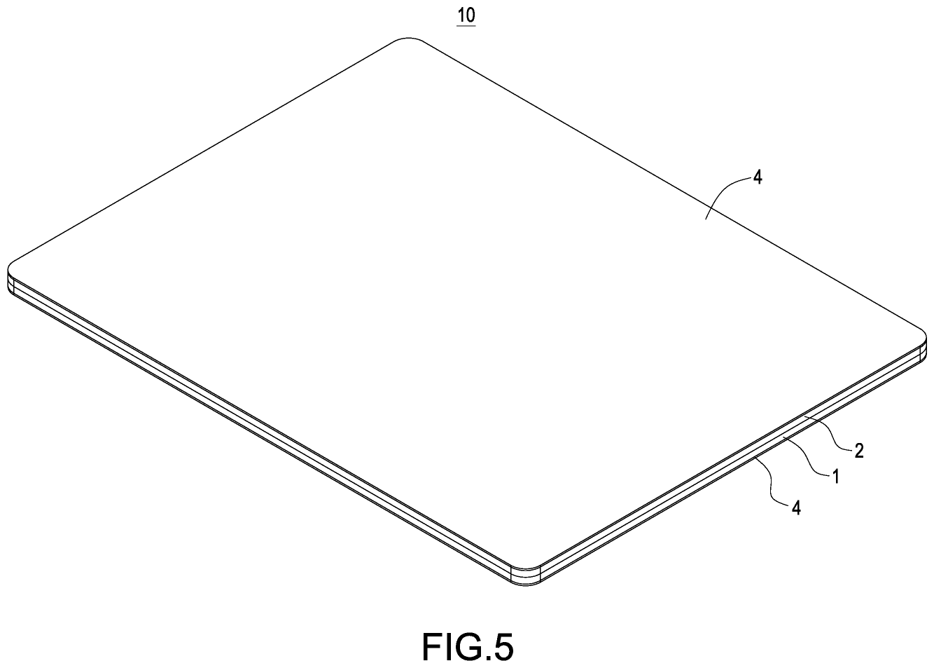

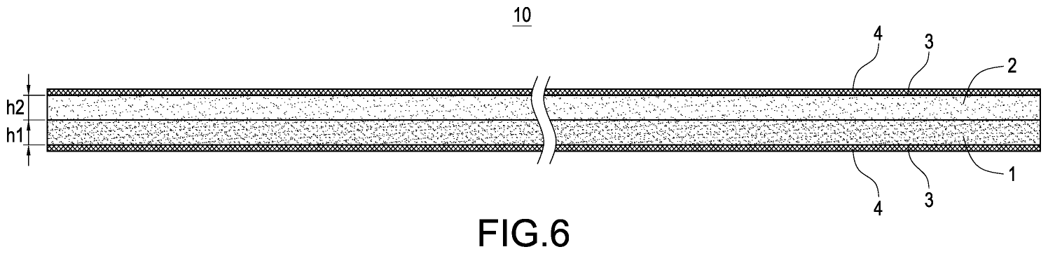

Please refer to FIG. 5 and FIG. 6, which disclose another embodiment of the mouse pad of the present disclosure. The embodiment disclosed in FIG. 5 and FIG. 6 is substantially the same as the embodiment disclosed in FIG. 1, FIG. 2, FIG. 3 and FIG. 4. The difference between the embodiment disclosed in FIG. 5 and FIG. 6 and the embodiment disclosed in FIG. 1, FIG. 2, FIG. 3 and FIG. 4. is that a hardness of the first pad plate 1 is greater than a hardness of the second pad plate 2.

Details are provided as follows. In some embodiments, the thickness h1 of the first pad plate 1 is the same as the thickness h2 of the second pad plate 2, and the material of which the first pad plate 1 is made is different from the material of which the second pad plate 1 is made. The Shore hardness of the first pad plate 1 is between about 30 to about 50, and the Shore hardness of the second pad plate 2 is between about 10 to about 30.

In some embodiments, the first pad plate 1 is hard plastic, the second pad plate 2 is rubber, or the first pad plate 1 and the second pad plate 2 are rubbers consisted of different compositions, but here is not intended to be limiting.

Accordingly, the hardness of the first pad plate 1 is greater than the hardness of the second pad plate 2, thus the surface of the first pad plate 1 is less likely to be deformed relative to the surface of the second pad plate 2, the two surfaces of the pad main body 10 have different smoothness, and the same functions and effects of the embodiment disclosed from FIG. 1, FIG. 2, FIG. 3 and FIG. 4 may be achieved.

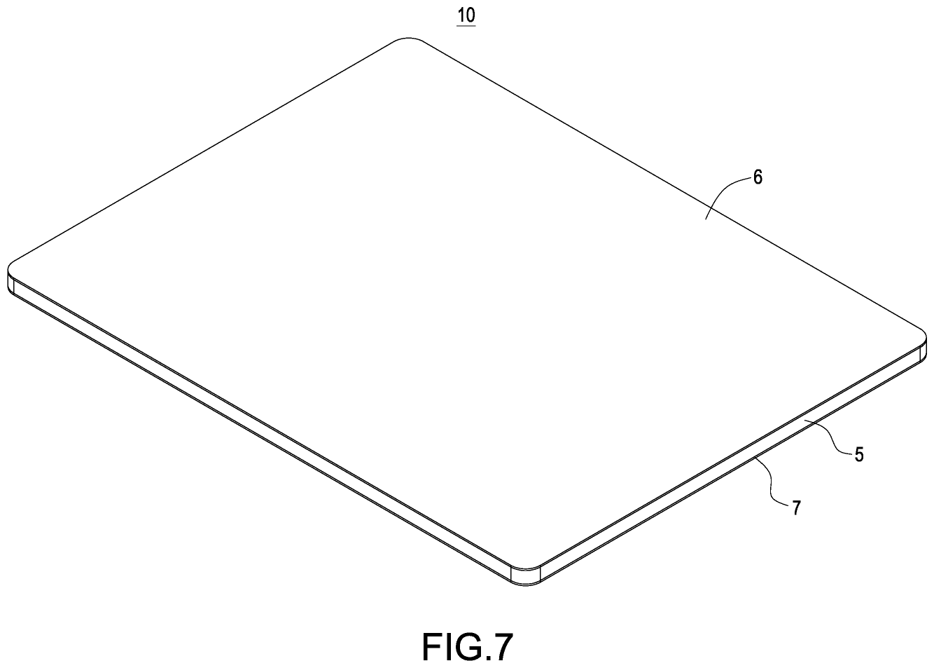

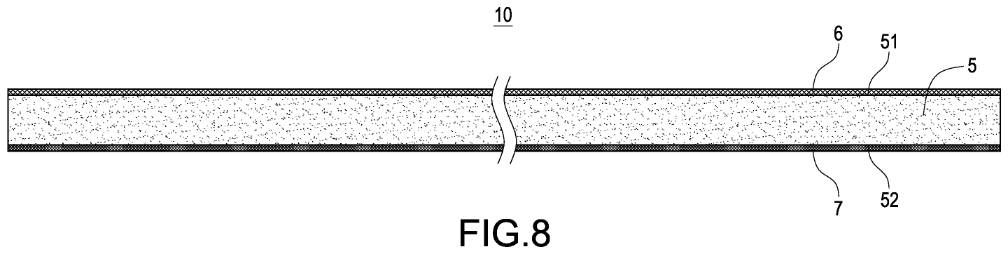

Please refer to FIG. 7 and FIG. 8, which disclose still another embodiment of the mouse pad of the present disclosure. The embodiment disclosed in FIG. 7 and FIG. 8 is substantially the same as the embodiment disclosed in FIG. 1, FIG. 2, FIG. 3 and FIG. 4. The difference between the embodiment disclosed in FIG. 7 and FIG. 8 and the embodiment disclosed in FIG. 1, FIG. 2, FIG. 3 and FIG. 4. is that the pad main body 10 includes a middle pad plate 5, a first surface layer 6 and a second surface layer 7.

Details are provided as follows. The middle pad plate 5 has a first surface 51 and a second surface 52 opposite to the first surface 51. The first surface layer 6 is adhered with the first surface 51. The second surface layer 7 is adhered with the second surface 52. A hardness of the second surface layer 7 is greater than a hardness of the first surface layer 6.

In some embodiments, the first surface layer 6 is a fabric layer, the second surface layer 7 is a plastic membrane layer, but here is not intended to be limiting. The first surface layer 6 and the second surface layer 7 may be fabric layers with different hardness, or the first surface layer 6 and the second surface layer 7 may be plastic membrane layers with different hardness. Moreover, the middle pad plate 5 may be hard plastic, silicone, rubber or any plastic foaming material such as thermoplastic rubber (TPE), thermoplastic polyurethane (TPU), and ethylene/ethylene-vinyl acetate copolymer (EVA).

Accordingly, the hardness of the second surface layer 7 is greater than the hardness of the first surface layer 6, thus the surface of the second surface layer 7 is less likely to be deformed relative to the surface of the first surface layer 6, the two surfaces of the pad main body 10 have different smoothness, and the same functions and effects of the embodiment disclosed from FIG. 1, FIG. 2, FIG. 3 and FIG. 4 may be achieved.

While this disclosure has been described by means of specific embodiments, numerous modifications and variations could be made thereto by those skilled in the art without departing from the scope and spirit of this disclosure set forth in the claims.

What is claimed is:

1. A mouse pad, comprising:
a pad main body, comprising a first pad plate and a second pad plate stacked on the first pad plate, wherein a thickness of the first pad plate is greater than a thickness of the second pad plate.

2. The mouse pad according to claim 1, wherein a material of which the first pad plate is made is the same as a material of which the second pad plate is made.

3. The mouse pad according to claim 1, further comprising: two surface layers, wherein the first pad plate and the second pad plate jointly comprise two outer surfaces, and the two surface layers are adhered on the two outer surfaces.

4. The mouse pad according to claim 1, further comprising: an anti-slippery pad, wherein the pad main body is disposed on the anti-slippery pad.

5. A mouse pad, comprising:
a pad main body, comprising a first pad plate and a second pad plate stacked on the first pad plate, wherein a hardness of the first pad plate is greater than a hardness of the second pad plate.

6. The mouse pad according to claim 5, wherein a Shore hardness of the first pad plate is between about 30 to about 50, and a Shore hardness of the second pad plate is between about 10 to about 30.

7. The mouse pad according to claim 5, wherein a material of which the first pad plate is made is different from a material of which the second pad plate is made, and a thickness of the first pad plate is the same as a thickness of the second pad plate.

8. The mouse pad according to claim 5, further comprising: two surface layers, wherein the first pad plate and the second pad plate jointly comprise two outer surfaces, and the two surface layers are adhered on the two outer surfaces.

9. The mouse pad according to claim 5, further comprising: an anti-slippery pad, wherein the pad main body is disposed on the anti-slippery pad.
